(19) United States
(12) Patent Application Publication
(10) Pub. No.: US 2025/0056675 A1
(43) Pub. Date: Feb. 13, 2025

(54) Electrical Heating Device

(71) Applicant: Eberspächer catem GmbH & Co.KG, Herxheim (DE)

(72) Inventors: Kai-Fabian Bürkle, Hiiinterweidenthal (DE); Markus Hoffmann, Beindersheim (DE); Jikang Wang, RÜlzheim (DE); Gaetan Ahoufack, Pirmasens (DE); Timo KrÖner, RÜlzheim (DE); Ralf Lothar Weinand, WÖrth am Rhein (DE); Sascha Herzig, Bad Bergzabem (DE); Ahmad Asafi, Karlsruhe (DE); Andreas Bachmann, BÖhl-lggelheim (DE); Fabian Beck, Landau in der Pfalz (DE); Carina Bauer, Bellheim (DE)

(21) Appl. No.: 18/795,428

(22) Filed: Aug. 6, 2024

(30) Foreign Application Priority Data
Aug. 10, 2023 (DE) 10 2023 121 383.0

(51) Int. Cl. H05B 3/00; H05B 3/18

(52) U.S. Cl. CPC H05B 3/0019; H05B 3/18; H05B 2203/01; H05B 2203/02; H05B 2203/021; H05B 2203/035

(57) ABSTRACT

An electrical heating device comprises an electrical heating assembly and a control device adapted to control the electrical heating assembly and a housing base part that is adapted to accommodate the control device. The housing part is connected to a housing cover to form a housing sealed from the environment. The control device and the electrical heating assembly are accommodated in the housing to create a compact design and the best possible EMC protection.

### BACKGROUND OF THE INVENTION

### 1. Field of the Invention

The present invention relates to an electrical heating device comprising an electrical heating assembly and a control device adapted to control the electrical heating assembly and a housing base part adapted to accommodate the control device, which housing base part is connected to a housing cover to form a housing sealed from the environment.

### 2. Background of Related Art

Such an electrical heating device is known, for example, from EP 2 884 197 A1 or EP 3 101 364 A1.

In this prior art, the electrical heating assembly protrudes from a partition wall of a housing and projects above this housing. The electrical heating assembly has PTC elements and electrically conductive contact sheets, the terminal lugs of which protrude into the housing, which in the prior art is a control housing. A corresponding prior art is also indicated by EP 3 334 243 A1.

The aforementioned prior art is based on the principle that the heat-emitting main side surfaces of the electrical heating assembly extend transversely to the partition wall and thus transversely to a main extension direction of the control housing. The corresponding heating ribs define separate accommodation spaces protruding from the housing.

### SUMMARY

On this basis, the present invention aims to provide an electrical heating device of the type mentioned introductorily, which is compact in structure. In particular, the electrical heating device of the present invention is in particular also intended to follow a structural principle which provides the best possible EMC protection so that other electrical and electronic components in a vehicle are not disturbed by the operation of the electrical heating device. The electrical heating device of the present invention is particularly suitable for operation with a high-voltage current, such as that used for drives in electric vehicles. According to the present invention, a high-voltage current is considered to be, in particular, a current of more than 400 volts, optionally more than 700 volts.

According to the present invention, the control device and the electrical heating device are accommodated in the housing.

The housing comprises a housing base part and a housing cover and may consist solely of the housing base part and the housing cover. The housing base part has a housing bottom, which is usually flat and bounds the housing, and which usually extends essentially parallel to the housing cover. These components of the housing are usually made of a metallic material; in any case, the materials have good electromagnetic shielding properties. Housings made of plastic with a shielding device incorporated in or surrounding the housing, for example formed by a wire mesh, are also possible. An accommodation space formed by the housing to accommodate all components of the electrical heating device may be defined solely by the two components, the housing base part and the housing cover.

In contrast to the previously mentioned prior art, in which the medium to be heated is accommodated in a heating chamber which is surrounded and defined on the one hand by the partition wall of the control housing and on the other hand by a fluid housing which may be formed from plastic, in the present invention the fluid to be guided in a fluid housing which is accommodated in the housing and is configured so as to be adapted for the passage of the medium to be heated. This fluid housing is usually self-contained and has only predetermined inlets and outlets through which the medium is introduced into or discharged from the fluid housing.

This fluid housing is coupled to the electrical heating assembly in a heat-conducting manner. In particular, this is understood to mean a heat-conducting abutment of the fluid housing against the electrical heating assembly. With regard to the most effective possible heat extraction, the fluid housing for this purpose is usually made of a material with good heat-conducting properties, usually a metal such as aluminum or an aluminum alloy. With regard to electrical insulation of the fluid housing relative to the electrical heating assembly, an insulating layer can be provided between the fluid housing and the electrical heating assembly, which can be formed, for example, by a plastic film, a ceramic plate or a coated plate or a combination of the aforementioned, for example by a ceramic plate covered with a plastic film or sandwiched therebetween.

According to a possible further development of the present invention, the electrical heating assembly is coupled in a heat-conducting manner to a housing bottom of the housing base part bounding a first heating chamber. Here too, an insulating layer as described above can be provided between the electrical heating assembly and the housing bottom. According to this, the electrical heating assembly may be provided between the fluid housing and the housing bottom, usually as a planar component with an extension parallel to the housing bottom and parallel to the fluid housing, which may be of planar configuration. To improve heat extraction, the electrical heating assembly is biased against the housing bottom and the fluid housing.

An elastic biasing device, in particular formed by a compressible material, may be provided for this purpose. This material can be located on the side of the fluid housing opposite the heating assembly and act there in such a way that the fluid housing is biased against the electrical heating assembly and the electrical heating assembly is biased against the housing bottom. In this variant, the elastic biasing device is located between the electrical heating assembly and the fluid housing. Alternatively or additionally, the biasing device can also be arranged between the electrical heating assembly and the housing bottom.

A plastic film, in particular a silicone film, which is provided between the fluid housing and the electrical heating assembly or between the fluid housing and the housing bottom, wherein the fluid housing is screwed to the housing, in particular the housing bottom of the housing base part, has also proven to be an elastic biasing device with regard to good heat extraction. The corresponding film usually has a base area which covers at least the ground area of the electrical heating assembly which extracts the heat. The film may have a thickness of not more than 0.8 mm; typically not more than 0.45 mm, and more typically not more than 0.30 mm. The corresponding film preferably has a Shore A hardness of between 25 and 70.

It has been shown that such a film can not only store certain bias voltages and pass them on to the electrical heating assembly so that it is abutted in a planar manner against both sides of the fluid housing or the housing bottom for heat extraction. Rather, such a film can also compensate for certain tolerances that regularly occur on the side of PTC elements. Such PTC elements may be part of the electrical heating assembly. The PTC elements are usually provided distributed in a planar manner relative to the housing bottom. The housing bottom thereby usually only defines a support surface for the PTC elements, but not directly their contact surface. Rather, an electrical insulating layer is usually placed on the housing bottom, which supports a contacting layer on the side facing away from the housing bottom. This contacting layer can be formed from a contact sheet. The contacting layer can also be applied as an electrically conductive coating on the electrically insulating layer. In other words, the contacting layer and the electrically insulating layer according to the present invention can be formed by a unitary component which provides several functional ranges. In any case, the said PTC elements are applied in an electrically conductive manner against the contacting layer and are energized via the same. The PTC elements are usually ceramic cuboid components that are provided with a metallization on opposite sides, usually on the opposite main side surfaces for current conduction.

The structure described above is provided in reverse order on the side opposite the housing bottom and thus between the electrical heating assembly and the fluid housing. In this context, an at least thermally symmetrical or almost thermally symmetrical configuration of the layers on both sides of the electrical heating assembly can achieve as equal a heat extraction as possible in the direction of the fluid housing on the one hand and the housing bottom on the other.

The aforementioned first heating chamber and a second heating chamber bounded by the fluid housing and defined by the latter may be configured almost identically in that the same flow conditions and the same heat transfer values to the medium to be heated are achieved on both sides.

According to a possible further development of the present invention, the control device has a printed circuit board which extends parallel to the previously mentioned housing bottom of the housing base part. At least one connector may be mounted in a sealed manner in this bottom, which has male plug contacts. These plug contacts are plug-contacted into the printed circuit board. In a corresponding manner, contact tongues and the terminal lugs forming them are also aligned for energizing the electrical heating assembly. In this way, the electrical contacting of all components to be electrically connected to the printed circuit board can be established by a single plug-in movement. The same also applies to one or all temperature sensor(s) monitoring the temperature of the medium to be heated at the inlet or outlet in one of the heating chambers. The printed circuit board, which may be partially equipped with electrical components, if necessary, including the temperature sensor, only needs to be inserted into the housing base part and contacted with the exposed contact tongues. For this purpose, the connectors are usually pre-assembled in a sealed manner on the housing bottom. Their male plug contacts end in the plane in which the printed circuit board comes to rest after assembly. The same may apply to all other contact tongues or male plug contacts that are initially mounted permanently in the housing base part.

The same applies to contact tongues that are electrically connected to one of the contacting layers. A terminal lug electrically connected to the contacting layer provided close to the housing bottom and forming the contact tongue at its free end may pass through a plane containing the heating elements of the heating assembly. The contact tongues electrically connected to the respective contacting layers may penetrate a plane containing the fluid housing.

Accommodating the printed circuit board in the housing provides the best possible EMC protection for the electrical heating device. The alignment of the male plug contacts or contact tongues enables easy mounting of the printed circuit board.

The control device can have a power switch that is coupled to the fluid housing in a heat-conducting manner. In this way, the power dissipated by the power switch is used for heating and in this process, the power switch is also cooled.

As can be seen from the above description, the present invention proposes an electrical heating device comprising a plurality of parallel layers, wherein both a fluid housing carrying the medium at least partially for heating and the control device are accommodated in the housing. For this purpose, the housing has a housing base part which forms the bottom and thus a contact surface for the electrical heating assembly inside the housing. A housing cover, which forms the first heating chamber, extends parallel to the side opposite the housing bottom. This usually extends parallel and with a comparable geometric configuration to the second heating chamber, which is formed inside the fluid housing. Thus, a roughly comparable heat extraction is achieved on both sides of the electrical heating assembly. The PTC elements, which may form the heating elements, are therefore uniformly deheated on both sides.

All electronic components of the electrical heating device are provided within the housing and shielded accordingly, so that the electrical heating device according to the present invention can be operated in the vehicle with good EMC protection.

Further layers of the layered structure of the electrical heating device are usually the printed circuit board and a housing cover extending parallel to it, which is usually connected to a circulating edge of the housing base part in a fluid-tight manner, usually by welding, so that all components inside the housing are hermetically sealed from the environment. Sealed connectors connected to the housing also help to protect the components inside the housing from environmental influences.

### BRIEF DESCRIPTION OF THE DRAWINGS

Further details and advantages of the present invention will become apparent from the following description of an embodiment in conjunction with the drawing. Therein it is shown by:

FIG. 1: a perspective exploded view of an embodiment of the present invention;

FIG. 2: a perspective exploded view of the housing base part and the heating chamber cover of the embodiment according to FIG. 1;

FIG. 3: a perspective exploded view of the fluid housing of the embodiment according to FIG. 1;

FIG. 4: a perspective top view of the housing base part partially equipped with components of the embodiment according to FIG. 1 and

FIG. 5: a sectional view of the first embodiment along the line V-V drawn in FIG. 4.

### DETAILED DESCRIPTION

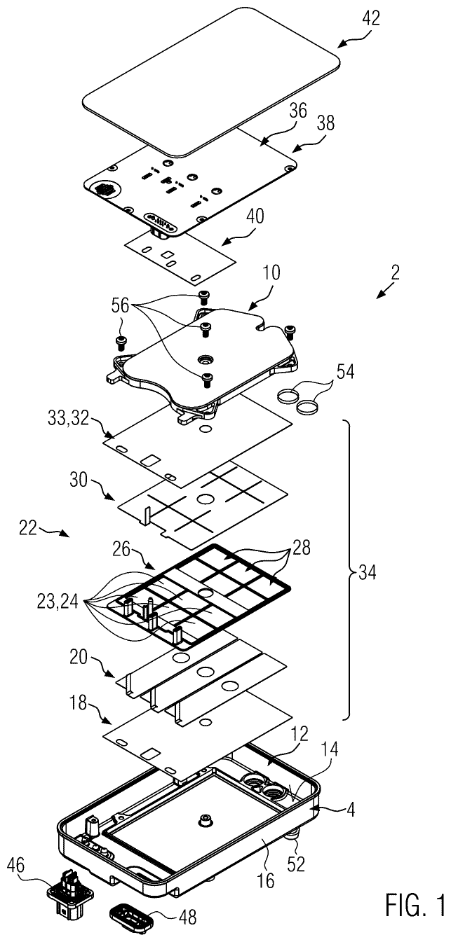

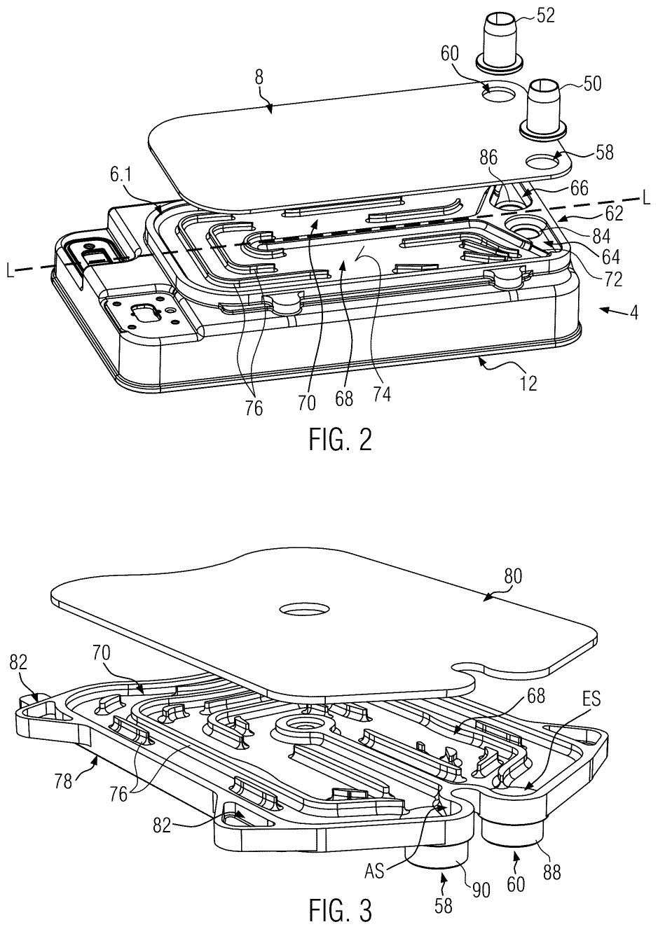

FIG. 1 shows an electrical heating device 2 with a housing base part 4, which is connected to a heating chamber cover 8 on its lower side in FIG. 1 to form a first heating chamber 6.1—see FIG. 2. Reference sign 10 characterizes a fluid housing, which is accommodated in an accommodation space 12 formed by the housing base part 4. In this accommodation space 12, which is bounded on the lower side by a bottom 14 and on the peripheral sides by a circumferential wall 16 extending from the bottom 14, and between the bottom 14 and the fluid housing 10, there is a first insulating layer 18, which can be abutted against the bottom 14, a first contacting layer 20 and a heating assembly 22 with a plurality of heating elements 23, in the present case in the form of PTC elements 24, and a positioning frame 26 with accommodations 28 for accommodating the PTC elements 24.

On the side opposite the first contacting layer 20 of the heating assembly 22, a second contacting layer 30 is provided, on the side of which opposite the heating assembly 22 a second insulating layer 32 is arranged. The PTC elements are therefore applied electrically conductive against the contacting layers 20, 30 and are energized via the same. The PTC elements 24 are ceramic cuboid components, which are provided with a metallization on opposite main side surfaces for current conduction. The main side surface is the surface of the cuboid with the largest surface area. The main side surfaces are connected to each other by peripheral surfaces that define the height of the PTC elements and have no metallization. The main side surfaces are generally each larger by a factor of 5 than one of the peripheral surfaces, typically than the sum of all the peripheral surfaces.

The second insulating layer 32 is formed as a biasing device 33 by a silicone film, which is capable of absorbing certain compressions by elastic deformation and thus arranging the electrical heating assembly 22 between the housing base part 10 and the housing bottom 14 and bias the same against the housing base part 10 and the housing bottom 14.

The layering of the first insulating layer 18, the first contacting layer 20, the heating de-vice 21, the second contacting layer 30 and the second insulating layer 32 is hereinafter also referred to as a layered structure 34.

On the side of the fluid housing 10 facing away from this layered structure 34, in the embodiment shown, a transistor insulation 40 is located between a printed circuit board 38 forming a control device 36 and the fluid housing 10. Reference sign 42 characterizes a housing cover which is connected to the housing base part 4 to form a housing characterized by reference sign 44 in FIG. 5. The housing base part 4 and the housing cover 42, possibly further housing parts, are configured to be shielding, that is, made of metal and/or provided with a separate shielding inside, outside or in the walls of the respective housing part, which are conceivably made of plastic. A typical metallic material is aluminum or, with a view to corrosion resistance, stainless steel.

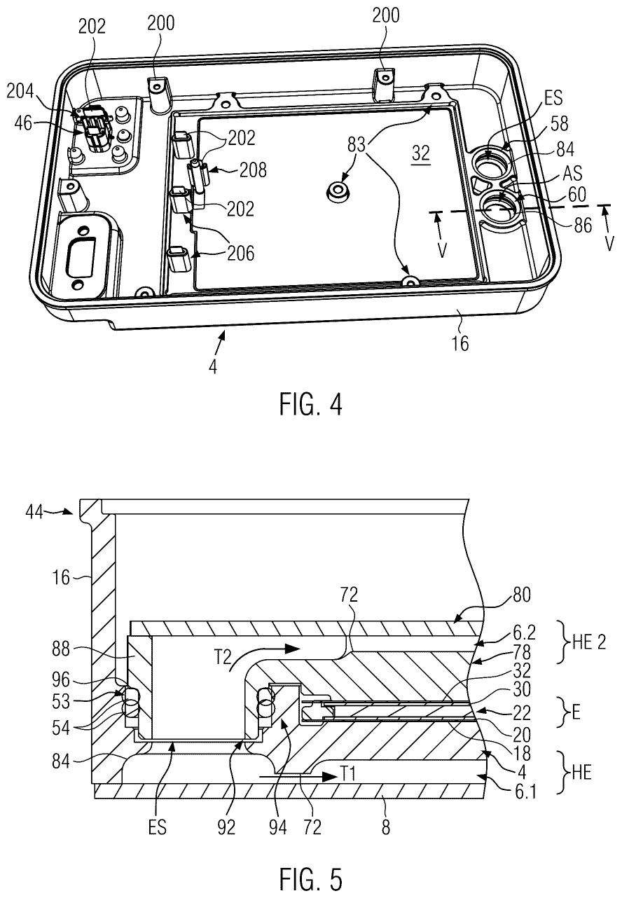

A power connector 46 and a control connector 48 are shown in FIG. 1 on the lower side of the housing base part 4 opposite this housing cover 42. These two connectors 46, 48 are connected to the housing base part 4 in a sealed manner and have various male electrical plug contacts which are led through the respective housings of the connectors 46, 48 in a sealed manner and are plug-contacted in the printed circuit board 38 and are electrically connected to strip conductors of the printed circuit board 38 via this plug contacting. Details of this are described below in conjunction with FIG. 4. For the plug contacting, the printed circuit board 38 has female contact tongue receptacles, which are described in EP 2 236 330 A1.

Furthermore, inlet and outlet nozzles 50, 52 are provided on the lower side for the connection of pipes or hoses which carry the fluid to be heated. Reference sign 53 characterizes the seal arrangement shown in FIG. 1 below the fluid housing 10, which in the present case is formed by two sealing rings 54, which are explained in more detail below. Reference sign 56 characterizes screws for fixing the fluid housing 10 opposite the housing base part 4 with interposition of the layered structure 34. Through this screw connection, the layers of the layered structure 34 are biased against the fluid housing 10 and the bottom 14 of the housing base part 4.

FIG. 2 shows an exploded view of the housing base part 4 and the heating chamber cover 8, which is shown spaced apart therefrom, and reveals the interior of the first heating chamber 6.1. It can be seen that the nozzles 50, 52 are formed by separate components which are flush with two bores within the heating chamber cover 8 formed from a flat sheet metal, one of which bores forms an inlet 58 and the other an outlet 60. The nozzles 50, 52 may be welded or bonded to the heating chamber cover 8.

Reference sign 62 characterizes a distributor arranged in a plane HE containing the first heating chamber 6.1. The distributor 62 has an inlet distributor section 64 and an outlet distributor section 66, which are each provided separately from each other and covered by the heating chamber cover 8. The respective distributor sections 64, 66 are provided symmetrically with respect to a longitudinal axis L of the housing base part 4 and are associated with an inlet branch 68 and an outlet branch 70 of the first heating chamber 6.1, respectively. In the top view, the distributor sections 64, 66 each have an approximately triangular ground area. Each distributor section 64, 66 merges into the respective branch 68, 70 via an overflow edge 72. The overflow edge 72 lies in the height direction between a first heating chamber bottom 74 of the first heating chamber 6.1 and an opposite cover surface of the first heating chamber 6.1 formed by the heating chamber cover 8.

Flow guide ribs 76 project from this first heating chamber bottom 74 to guide the flow, against which the heating chamber cover 8 abuts in a fluid-tight manner.

The inlet 58 or the outlet 60 in each case is arranged such that it partially covers the first heating chamber 6.1 and partially covers the respective distributor section 64, 66. The overflow edge 72 passes approximately centrally through the bore forming the inlet 58 or the outlet 60.

Details of the second heating chamber 6.2 can be seen in FIG. 3. The fluid housing 10 is formed by a fluid housing base part 78 and a fluid housing cover 80 welded thereto. The second heating chamber 6.2 also comprises flow guide ribs 76. A plurality of fastening eyes 82 are provided on the circumference of the fluid housing 10, through which the screws 56 are guided in order to connect the fluid housing 10 to the housing bottom 14 with the electrical heating assembly 22 interposed. In FIG. 4, threads formed on the housing bottom 14 are characterized by reference sign 83.

In FIG. 4, reference sign 84 characterizes a first inlet channel section and reference sign 86 characterizes a first outlet channel section. These channel sections 84, 86 are formed on and through the housing base part 4. FIG. 3 shows second inlet and outlet channel sections 88, 90 formed integrally on the fluid housing base part 78.

As conveyed in particular by FIG. 5, the second channel sections 88, 90 are formed as tip ends 92, each engaging a bushing end 94 formed by the first channel sections 84, 86, wherein the seal arrangement 53 is provided therebetween and abuts in an axial and radial direction against an abutment shoulder 96 provided on the respective tip end 92.

The tip end 92 and the bushing end 94 have an axial length such that electrical heating assemblies 22 having different thicknesses can be arranged between the fluid housing 10 and the housing bottom 14, without loss of sealing between the housing base part 4 and the fluid housing 10. As a result, an inlet flow connection ES formed by the inlet channel sections 84, 86 is variable in length transverse to the plane E containing the electrical heating assembly 22. The same applies to an outlet flow connection characterized by reference sign AS.

The fluid flow introduced into the electrical heating device 2 through the inlet 58 is divided into two partial flows in the area of the distributor 62. The first partial flow T1 flows via the overflow edge 72 into the first heating chamber 6.1 whereas the second partial flow T2 passes through the inlet flow connection ES, flows through the second heating chamber 6.2, first through the inlet branch 68 and then through the outlet branch 70, and finally through the outlet flow connection AS, is brought together with the first partial flow T1 in the area of the distributor 62 and the fluid flow resulting from the combination of these two partial flows T1, T2 is discharged through the outlet.

FIG. 4 also conveys the electrical connection concept for the printed circuit board 38. Contact tongues 202 of male plug contacts 204, which are exposed at the free ends of the connectors (only the power connector 46 is shown) or at the free ends of terminal lugs 206 of the minus contacts or at the free ends of terminal lugs 208 of the plus contact, protrude into a mounting plane of the printed circuit board 38, which is recognizable by supports 200 for the printed circuit board 38. The terminal lugs 206, 208 also protrude beyond the fluid housing 10 after assembly, which is arranged below the mounting plane of the printed circuit board 38. The printed circuit board 38 can be plug-contacted with all contact tongues 202 by simply lowering it in the direction of the housing bottom 14, that is, in a direction orthogonal to the flat extension of the housing bottom 14. The mounted printed circuit board 38 rests on the supports 200 and is fixed against the housing base part 4 by means of screws, not shown, which are engaged in threads of the supports 200.

The solution described here offers the following advantages:
1. Since the electrical heating assembly 22 is provided within the metallic housing 44, this results in good EMC shielding.
2. Since a heating chamber 6.1; 6.2 is provided on each side of the electrical heating assembly 22, heat is emitted to the medium to be heated on both main sides of the electrical heating assembly 22.
3. Since the medium to be heated is divided into partial flows T1, T2, the same heating conditions prevail on both sides of the electrical heating assembly 22. This also applies to the respective branches 68, 70. Thus, the PTC elements 24 provided distributed relative to the housing bottom 14 are each located between the heat dissipating surfaces provided by the first or second heating chamber 6.1; 6.2, which apply the same temperature gradient to the respective PTC elements 24.
4. All housing parts are made of aluminum or an aluminum alloy and thus save weight.
5. All housing parts 4, 20; 78, 80 bounding the respective heating chamber 6.1; 6.2 are welded together directly and in a fluid-tight manner, which results in a high degree of reliability with regard to sealing.
6. Moreover, heating chambers 6.1; 6.2 can be tested for tightness after joining the housing parts 4, 20; 78, 80 forming the heating chambers 6.1; 6.2 and before final assembly of the electrical heating device 2.
7. Since the flow connections ES and AS for the inlet or outlet of the medium are variable in length, electrical heating assemblies 22 of different thickness and thus different performance can be installed without having to change the housing parts 4, 20; 78, 80 defining the first or second heating chamber 6.1, 6.2.
8. The distributor 62 enables the same partial flows T1, T2 to be divided with the same volume flow with low differential pressure loss.
9. The inlet and outlet nozzles 50; 52 are connected to the housing base part 4 as separate components, so that these interfaces can be adapted for the connection of tubes or lines according to customer requirements without having to change the components defining the first or second heating chamber 6.1, 6.2.

1. An electrical heating device comprising:
an electrical heating assembly;
a control device adapted to control the electrical heating assembly; and
a housing base part adapted to accommodate the control device and connected to a housing cover to form a housing sealed from the environment, wherein the control device and the electrical heating assembly are accommodated in the housing.

2. The electrical heating device according to claim 1, further comprising a fluid housing accommodated in the housing, wherein the fluid housing is configured so as to be adapted for the passage of a medium to be heated and is coupled in a heat-conducting manner to the electrical heating assembly.

3. The electrical heating device according to claim 2, wherein the electrical heating assembly is coupled in a heat-conducting manner to a housing bottom, wherein the housing bottom bounds a first heating chamber of the housing base part and is biased against the housing bottom and the fluid housing.

4. The electrical heating device according to claim 3, wherein the electrical heating assembly is biased against the housing bottom and the fluid housing by an elastic biasing device, wherein the elastic biasing device is arranged between the electrical heating assembly and the fluid housing and/or between the electrical heating assembly and the housing bottom.

5. The electrical heating device according to claim 1, wherein the electrical heating assembly is formed by a layered structure comprising heating elements contacting layers abutting on opposed sides thereof and electrical insulating layers which cover the contacting layers on an outside thereof.

6. The electrical heating device according to one claim 5, wherein the heating elements are PTC elements.

7. The electrical heating device according to claim 5, wherein the housing base part forms a housing bottom against which one of the electrical insulating layers of the layered structure abuts, and wherein the other of the electrical insulating layers abuts against the fluid housing.

8. The electrical heating device according to claim 1, wherein the control device has a printed circuit board which extends parallel to a housing bottom that is formed by the housing base part, and wherein at least one connector is mounted in a sealed manner in the housing bottom, wherein the connector has male plug contacts which are plug-contacted in the printed circuit board.

9. The electrical heating device according to claim 1, wherein the control device comprises a power switch which is coupled to the fluid housing in a heat-conducting manner.

10. The electrical heating device according to claim 5, wherein one of the contacting layers is electrically connected to at least one terminal lug, and wherein the terminal lug is plug-contacted in a printed circuit board of the control device and passes through a plane containing the heating elements.

11. The electrical heating device according to claim 10, wherein the one contacting layer is formed of sheet metal, and wherein the terminal lug forms part of said sheet metal and is bent to pass through a plane containing the heating elements.

12. The electrical heating device according to claim 5, wherein a first heating chamber is formed outside the housing and a second heating chamber is formed inside the housing, wherein the first heating chamber and the second heating chamber are coupled to the electrical heating assembly in a heat-conducting manner, and wherein a fluid flow leading to the second heating chamber passes through a plane containing the heating device.
